(19) United States
(12) Patent Application Publication
(10) Pub. No.: US 2019/0377562 A1
(43) Pub. Date: Dec. 12, 2019

(54) DECENTRALIZED SOFTWARE INFORMATION ESTABLISHMENT SYSTEM

(71) Applicant: TAI-SHENG HAN, New Taipei (TW)

(72) Inventor: TAI-SHENG HAN, New Taipei (TW)

(21) Appl. No.: 16/244,105

(22) Filed: Jan. 10, 2019

(30) Foreign Application Priority Data
Jun. 7, 2018 (TW) 107119709

(51) Int. Cl. G06F 8/61; H04L 29/08; H04L 9/32

(52) U.S. Cl. CPC G06F 8/61; H04L 9/3226; H04L 67/34

(57) ABSTRACT

The present invention provides a decentralized software information establishment system, including at least one software supplier, at least one data node, at least one software client, and at least one software supplier, where the software supplier comprises a software product and transmits a software product information of the software product to a public network platform by using an Application; the data node captures the software product information, converts the captured software product information into a software product information repository, and then stores the software product information repository onto the public network platform; and further, the software client reads the software product information repository, generates a software usage serial number to use the software product, generates usage data of the software product, and transmits the software product information to the public network platform by using the Application for verification performed by the data node.

### BACKGROUND OF THE INVENTION

### 1. Technical Field

The present invention relates to a decentralized software information establishment system being impartial and being capable of clearly recording product history to query and update for delivery information and usage attachment data of a software product, thereby facilitating evaluation.

### 2. Background

Usually, every software product after delivery has its own software information, for example, relevant product information such as a name of a software vendor, a name of the software product, a version of the software product, and a launch date of the software product. Most of the pieces of product information are presented in product descriptions. However, when a consumer wants to buy the software product, the consumer can merely learn of a brief introduction to the software product from an introduction made by a shop assistant, Packing Information, or an online introduction, and cannot really clearly learn of its complete information. Consequently, there is no guarantee for the consumer, and the consumer may even buy an illegal counterfeit product having the same product serial number. Moreover, after buying a software product, a consumer first obtains a usage serial number for the software product, and installs a plug-in or makes an achievement by using the usage serial number. However, when the consumer wants to sell the Software, a subsequent consumer cannot clearly determine whether the plug-in or achievement added by using the usage serial number is fake, and consequently, many consumption disputes may occur. Moreover, currently, there are many methods for publishing product history on the market. The principle method is that a manufacturer is utilized to integrate and publish data. However, if only the manufacturer records or publishes data, a lot of problems would occur because integration of product data is always performed unilaterally, and the integrated data cannot achieve the best impartiality. In addition, with development of network technologies, a single host cannot bear and process a large quantity of files and information repositories. In the past, although computing and processing capabilities are enhanced by continuously improving hardware specifications or connecting a plurality of hosts, when a failure occurs in a central information repository, the overall architecture cannot operate. Although it is additionally proposed that, by means of a directory management manner, an index is first queried, and then, information repositories of different hosts are entered to access files, storing a directory management system into a core host still has a risk that query cannot be performed when the core host fails.

Therefore, how to resolve the foregoing conventional problems and disadvantages is a direction in which the inventor of the present invention and relevant manufacturers in this industry urgently want to conduct researches and make improvements.

### SUMMARY OF THE INVENTION

In view of the above, to effectively resolve the foregoing problems, a main objective of the present invention is to provide a decentralized software information establishment system being impartial and being capable of clearly recording product history to query and update for delivery information and usage attachment data of a software product, thereby facilitating evaluation.

To achieve the foregoing objective, the present invention provides a decentralized software information establishment system, including at least one software supplier, at least one data node, and at least one software client, where the software supplier includes at least one software product, the software supplier provides software product information for the software product developed by the software supplier, and the software supplier transmits the software product information to a public network platform by using an Application; in addition, the data node captures the software product information from the public network platform by using the Application, converts the captured software product information into a software product information repository, and then stores the software product information repository onto the public network platform by using the Application; and further, the software client reads the software product information repository on the public network platform by using the Application, the software client uses the software product by using a software usage serial number, generates usage data of the software product, and transmits the software product information to the public network platform by using the Application, and when there is the usage data of the software product on the public network platform, the data node performs verification on the software product information, the software usage serial number, and the usage data of the software product, forms the software product information repository, and stores the software product information repository onto the public network platform. In this way, the product history including the software product delivery information and the usage data of the software product can be clearly recorded on the public network platform, and further, the data node performs verification on its delivery information, software usage serial number, and usage data of the software product, to facilitate evaluation on the software product information repository of the public network platform. In addition, features of distributed computation and authentication and unilaterally-unchangeable data of decentralization enable a trader to have an impartial scoring standard during a product transaction.

### BRIEF DESCRIPTION OF THE DRAWINGS

FIG. 1 is a schematic diagram of a decentralized software information establishment system according to the present invention; and

FIG. 2 is a schematic block diagram of a decentralized software information establishment system according to the present invention.

### DETAILED DESCRIPTION OF THE PREFERRED EMBODIMENTS

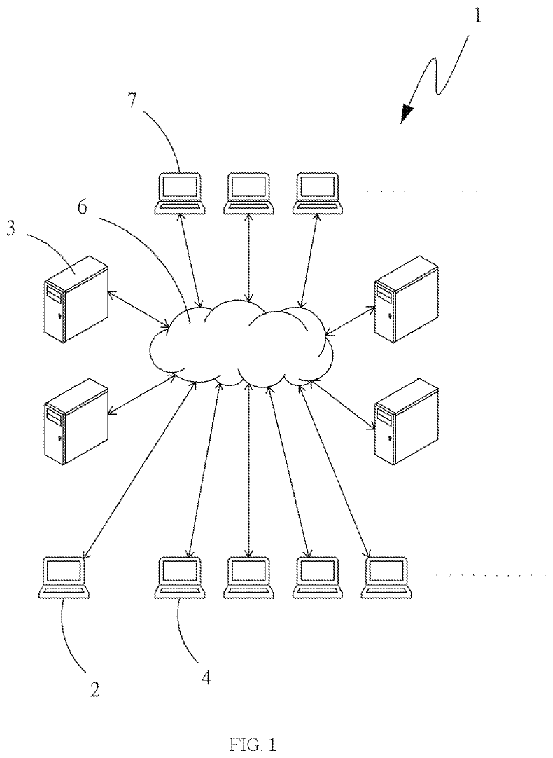

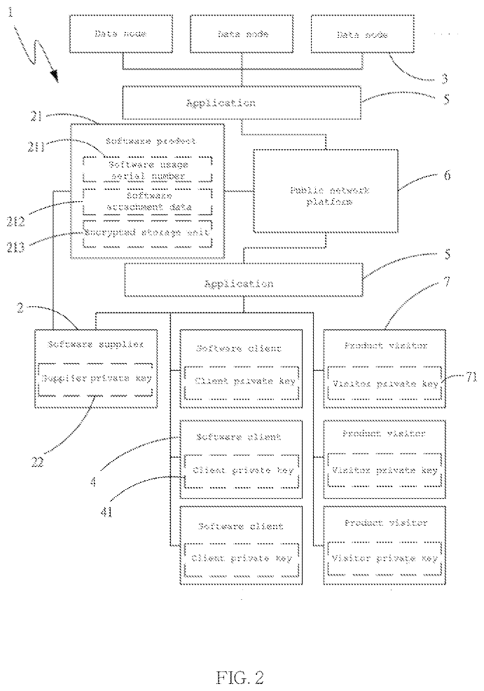

Referring to FIG. 1 and FIG. 2, FIG. 1 and FIG. 2 are a schematic diagram and a schematic block diagram of a decentralized software information establishment system according to the present invention. It could be clearly learned from the figures that the decentralized software information establishment system 1 includes at least one software supplier 2, at least one data node 3, and at least one software client 4 The software supplier 2 may generate at least one software product 21, the software product 21 may be a game program, an operating system, or operation software, and the software supplier 2 generates product information for the software product 21. The product information may include relevant product information such as a name of a software vendor, a name of the software product 21, aversion of the software product 21, and a launch date of the software product 21. An Application 5 is installed on the software supplier 2 by using a computer device, and the software supplier 2 transmits the software product information to a public network platform 6 by using the Application 5. In addition, the software supplier 2 writes the software product information onto the public network platform 6 by using a supplier private key 22. The supplier private key 22 includes a first public key and a second private key to which the supplier belongs. The first public key is an information reading mode, and the second private key is an identity matching mode. Therefore, the public network platform 6 stores product information of various software products 21. The software product 21 of the software supplier 2 may be provided on a software supply platform or an optical disc. The software supply platform may be Microsoft store, Steam, Appstore, or GooglePlay, but is not limited thereto. Further, the software supply platform may include the Application 5, and the software supplier 2 transmits the software product information to the public network platform 6 by using the Application 5 of the software supply platform.

In this case, the Application 5 is also installed on the data node 3 by using a computer device, and the data node 3 may capture the software product information on the public network platform 6 by using the Application 5, and perform verification on the captured software product information. The product information that is verified to be correct is converted into a software product information repository, and the software product information repository is stored onto the public network platform 6 by using the Application 5.

In addition, when the software client 4 buys the software product 21, the software client 4 may install the Application 5 in a computer device thereof, or reads, on the public network platform 6 by using the Application 5 on the software supply platform, a software product information repository to which the software product 21 bought by the software client 4 belongs, and learns of the product information of the software product 21 from the software product information repository. Moreover, the software client 4 reads the software product information repository by using a client private key 41 to which the client belongs. The client private key 41 includes a first secret key and a second secret key to which the client belongs. The first secret key is an information reading mode, and the second secret key is an identity matching mode. In addition, the software client 4 generates a software usage serial number 211 before using the software product 21, and the software client 4 uses the software product 21 by using the software usage serial number 211. The software product 21 used by the software client 4 by using the software usage serial number 211 may be added with at least one piece of software attachment data 212 and generate usage data of the software product 21. The software attachment data 212 may be a software plug-in or an achievement obtained from Gameplay, and the software client 4 transmits the usage data of the software product 21 to the public network platform 6 by using the Application 5. Moreover, the data node 3 performs verification on the software product information and the usage data of the software product 21, forms the software product information repository, and stores the software product information repository onto the public network platform 6. In addition, the software product includes an encryption storage unit 213. The encryption storage unit 213 stores the software product information repository, and the software product information repository is transmitted to the public network platform 6 by using the Application 5. In addition, the encryption storage unit 213 may be an attached software file or an embedded software program. Further, the encryption storage unit 213 and the public network platform 6 may communicate and authenticate each other by using the Application 5.

In this case, the data node 3 may capture a software product information repository, the software usage serial number 211, usage information of the software product 21 on the public network platform 6 by using the Application 5, and performs verification on the captured software product information repository, software usage serial number 211, and usage information of the software product 21. The software product information repository, the software usage serial number 211, the usage information of the software product 21 that are verified to be correct are converted into a same product information repository, and the product information repository is stored onto the public network platform 6 by the Application 5. The product information repository on the public network platform 6 not only can be read and written by the software supplier 2, but also can be read and written by the software client 4, and the data node 3 performs verification on the data written by both of the software supplier 2 and the software client 4, so that it is convenient to evaluate the product information repository of the public network platform 6. In addition, features of distributed computation and authentication and unilaterally-unchangeable data of decentralization enable a trader to have an impartial scoring standard during a product transaction.

Moreover, when the public network platform 6 includes the software product information repository, the software product information repository may be further read by at least one product visitor 7. The Application 5 is installed on a computer device of the product visitor 7, or the Application 5 is built in the software supply platform, so that the product visitor 7 can read the software product information repository by using the Application 5. The product visitor 7 reads the software product information repository by using a visitor private key 71. Moreover, the visitor private key 71 is a data reading mode, and the visitor private key 71 only has permission to read data, so that the product visitor 7 thereof can learn of software product information of the software product 21 and usage data of the software product 21 by using the software product information repository, the product visitor 7 may further clearly learn of product history of the software product 21, and its software product information repository is a result of distributed computation of decentralization. Further, data in its software product information repository facilitates evaluation and has impartiality, so that it would be convenient for the software supplier 2, the software client 4, and the product visitor 7 to clearly learn of their correct data, thereby preventing a consumption dispute.

Furthermore, if the product visitor 7 reads the software product information repository, and after the software product 21 is bought and used by the product visitor 7, the product visitor 7 is converted into a software client 4. The software client 4 can generate usage data of the software product 21 by using the client private key 41 and the Application 5. By means of the usage data of the software product 21, the software client 4 can use the software product 21 by using the software usage serial number 211, and is added with the software attachment data 212.

Moreover, the data node 3 can capture the software product information repository and the usage data of the software product 21 on the public network platform 6 by using the Application 5, and performs verification on the captured software product information repository and usage data of the software product 21. The software product information repository and the usage data of the software product 21 that are verified to be correct are converted into a same software product information repository, and are stored onto the public network platform 6 by using the Application 5, so that it would be convenient to evaluate the software product information repository of the public network platform 6. By means of features of distributed computation and authentication and unilaterally unchangeable data of decentralization, an impartial transaction of the software product 21 is performed. It should be additionally noted that the product information and usage data of the product are verified to be correct by using a block chain technology, but is not limited thereto. In this way, by means of features of distributed computation and authentication and unilaterally unchangeable data of decentralization, the software product information repository of the public network platform 6 has reliability and impartiality, and compared with a common transaction mode based on discretion, the verified software product information repository is closer to the actual product value, and in terms of product transactions, a trader is provided with an impartial scoring standard.

It should be noted that the foregoing descriptions are merely preferred embodiments of the present invention and are not intended to limit the present invention. Changes, such as changes to the construction or layout, made according to the concept of the present invention without departing from the scope of the spirit of the present invention, and equivalent effects produced by various changes, modifications, and applications all fall within the scope of the claims of the present invention.

What is claimed is:

1. A decentralized software information establishment system, comprising:
at least one software supplier, wherein the software supplier comprises at least one software product, the software product comprises software product information, and the software supplier transmits the software product information to a public network platform by using an Application;
at least one data node, wherein the data node captures the software product information by using the Application, converts the software product information into a software product information repository, and stores the software product information repository onto the public network platform by the Application; and
at least one software client, the software client reads the software product information repository on the public network platform by using the Application, the software client uses the software product by using a software usage serial number and transmits the software product information to the public network platform by using the Application, and the data node performs verification on the software product information, forms the software product information repository, and stores the software product information repository onto the public network platform.

2. The decentralized software information establishment system according to claim 1, wherein the software product of the software supplier is provided on a software supply platform, and the software client downloads the software product from the software supply platform and generates the software usage serial number at the same time.

3. The decentralized software information establishment system according to claim 2, wherein the software supply platform comprises the Application, and the software supplier transmits the software product information to the public network platform by using the Application of the software supply platform.

4. The decentralized software information establishment system according to claim 2, wherein the software product used by the software client by using the software usage serial number is added with at least one piece of software attachment data and generates usage data of the software product, the software client transmits the usage data of the software product to the public network platform by using the Application, and the data node performs verification on the software product information and the usage data of the product, forms the software product information repository, and stores the software product information repository onto the public network platform.

5. The decentralized software information establishment system according to claim 4, wherein the software product is a game program, an operating system, or operation software, and the software attachment data is a software plug-in or Gameplay Achievement.

6. The decentralized software information establishment system according to claim 1, wherein the software supplier reads the software product information repository by using the Application, and the software product information is written onto the software supply platform by using a supplier private key, wherein the supplier private key comprises a first public key and a second private key, the first public key is an information reading mode, and the second private key is an identity matching mode.

7. The decentralized software information establishment system according to claim 1, wherein the software client reads the software product information repository by using the Application, writes the software product information and the usage data of the software product by using a client private key, and transmits them onto the public network platform, wherein the supplier private key comprises a first public key and a second private key, the first public key is an information reading mode, and the second private key is an identity matching mode.

8. The decentralized software information establishment system according to claim 1, further comprising at least one product visitor, wherein the product visitor reads the software product information repository by using the Application, and reads the product information repository by using a visitor private key, wherein the visitor private key is an information reading mode.

9. The decentralized software information establishment system according to claim 1, wherein the software product comprises an encryption storage unit, the encryption storage unit stores the software product information repository, the product information repository is transmitted to the public network platform by using the Application, the encryption storage unit is an attached software file or an embedded software program, and the encryption storage unit and the public network platform communicate and authenticate each other by using the Application.
